(19) United States
(12) Patent Application Publication
(10) Pub. No.: US 2019/0316717 A1
(43) Pub. Date: Oct. 17, 2019

(54) FLUID CIRCUIT COMPRISING A FIRST PIPE, A SECOND PIPE AND A COUPLING, AND COUPLING METHOD

(71) Applicant: Stelia Aerospace, Rochefort (FR)

(72) Inventors: Damien Sireude, Nantes (FR); Daniel Perherin, Pont Aven (FR); Thierry Aletrut, Leguevin (FR); Pascal Solana, Mondonville (FR); Dimitri Rouyard, Saint-Nazaire (FR)

(73) Assignee: Stelia Aerospace, Rochefort (FR)

(21) Appl. No.: 16/469,884

(22) PCT Filed: Dec. 6, 2017
(86) PCT No.: PCT/EP2017/081732

§ 371 Date: Jun. 14, 2019

(30) Foreign Application Priority Data
Dec. 19, 2016 (FR) 1662701

(51) Int. Cl. F16L 37/138; F16L 25/12; F16L 37/12; F16L 17/02

(52) U.S. Cl. CPC F16L 37/138; F16L 17/02; F16L 37/1225; F16L 25/12

(57) ABSTRACT

A fluid circuit, particularly for an aircraft, comprising a first pipe, a second pipe and a coupling comprising an outer sleeve which extends along an axis X and is mounted with the ability to slide along the axis X at a connection ends of the first pipe, a sealing member which extends along the axis X and is mounted with the ability to slide along the axis X in said outer sleeve, the sealing member being configured to sealingly connect the connection ends of the pipes, locking means configured to collaborate with a blocking member of the second pipe so as to block the translational movement of said outer sleeve towards the first pipe, the coupling being configured to move the sealing member between the two connection ends in order to provide sealing as the outer sleeve is moved as far as the blocking member of the second pipe.

### TECHNICAL FIELD

The present invention relates to the field of fluid circuits in an aircraft, for example, a circuit for drinking water, wastewater, draining, etc.

In a known manner, a fluid circuit comprises a plurality of pipes mechanically and fluidically connected together. During the setting in place of a fluid circuit in an aircraft, the pipes are secured independently to the structure of the aircraft then coupled together fluidically. In other words, the pipes are not movable in relation to the others but fixed during a coupling, except for thermal expansion. In practice, a small axial clearance can be considered in order to make it possible for the considering of relative deformations or movement between the pipes and the surrounding bearing structure.

To couple a first pipe to a second pipe, it is known to use an elastic sleeve in order to join the two ends of the pipes. To ensure the sealing between the sleeve and each pipe, a clamping ring must be mounted at each end of the sleeve. Such a coupling has many disadvantages. Indeed, setting the sleeve and clamping rings in place is time-consuming and hardly practical, which increases the cost of setting up a fluid circuit. A coupling device is moreover known by patent application EP0616161 comprising mechanical claws, but the latter are likely to scratch/damage the pipes, which is not acceptable for a qualitative application in the aeronautical field.

The invention therefore aims to overcome these disadvantages by proposing a new type of coupling and a new method of coupling two fixed pipes, in particular, for an aeronautical application.

### SUMMARY

To this effect, the invention relates to a fluid circuit, particularly for an aircraft, comprising a first pipe, a second pipe and a coupling,

each pipe comprising a connection end, which extends along an axis X and which defines an inner surface and an outer surface, which comprises a blocking member extending as a radial protrusion with respect to said axis X from the outer surface, the connection ends of the pipes being fixed and spaced apart by an axial connection clearance,

the coupling comprising:
an outer sleeve which extends along the axis X and is mounted with the ability to slide along the axis X at the connection end of the first pipe, the outer sleeve being configured to connect the two connection ends during a movement from upstream to downstream,
a sealing member which extends along the axis X and is mounted with the ability to slide along the axis X in said outer sleeve, the sealing member being configured to sealingly connect the two connection ends,
locking means configured to collaborate with the blocking member of the second pipe to block the translational movement of said outer sleeve upstream towards the first pipe,

the coupling being configured to move the sealing member between the two connection ends to ensure sealing as the outer sleeve is moved downstream as far as the blocking member of the second pipe.

Thanks to the invention, two pipes separated by an axial connection clearance can be physically and fluidically connected through a simple movement downstream of the coupling. Indeed, the coupling makes it possible, on the one hand, to physically attach the pipes together thanks to the outer sleeve and, on the other hand, to fluidically connect the pipes thanks to the sealing member. Advantageously, the outer sleeve makes it possible to precisely set in place the sealing member at the interface between the pipes, which ensures an optimum sealing.

Furthermore, such a coupling makes it possible for an operator to couple the pipes in a simple and practical manner, by simply moving the outer sleeve onto the first pipe. A coupling can thus be carried out with a single hand by one operator.

In addition, the coupling has few elements of a simple structure which can be manufactured at a limited cost, which is advantageous.

Preferably, the sealing member can be removed from the outer sleeve, which advantageously makes it possible to replace said sealing member in case of wear.

Preferably, the outer sleeve comprises first abutment means configured to collaborate with the sealing member in order to move it concomitantly with the movement of the outer sleeve downstream. Thus, the sealing member is on hold before the coupling and is moved into a position of use, solely when a coupling is desired.

Preferably, the first abutment means are presented in the form of a first inner abutment wall, preferably, annular.

More preferably, the first abutment means extend radially outside the blocking member of the first pipe with respect to the axis X. Thus, the first abutment means do not come into contact with the blocking member during the downstream movement.

According to an aspect of the invention, the outer sleeve comprises second abutment means configured to collaborate with the blocking member of the first pipe to prevent the removal of the outer sleeve of the first pipe. Thus, the outer sleeve cannot be removed from the first pipe downstream due to the presence of the blocking member.

Preferably, the outer sleeve comprising an upstream end intended to extend on the side of the first pipe in the locked position and a downstream end intended to extend on the side of the second pipe in the locked position, the locking means are mounted at the downstream end of the outer sleeve.

Preferably, the locking means are configured to extend downstream of the blocking member of the second pipe in the locked position. Thus, the outer sleeve can no longer be moved upstream.

According to a preferred aspect, the locking means being deformable between the locked state and the unlocked state thereof, the coupling comprises securing means configured to prevent a deformation of the locking means in the locked state. Thus, the locking is automatic during the movement of the outer sleeve. Such locking means furthermore make it possible to prevent any damage/scratching of the pipes, which is essential for an aeronautical application.

Preferably, the locking means are configured to be deformed radially during the contact thereof with the blocking member of the second pipe during the movement of the coupling downstream. Preferably, the blocking member of the second pipe comprises, for this purpose, a flared wall so as to guide the deformation of the locking means. Preferably, the locking means are adapted to be deformed under the effect of a mechanical force applied by the operator. More preferably, the locking means are made of an elastic material so as to elastically retract after contact with the blocking member of the second pipe.

Preferably, the locking means have the form of a peripheral locking member mounted inside the outer sleeve. More preferably, the locking member comprises two hinged jaws adapted to be opened in the unlocked state and closed in the locked state.

Preferably, the downstream end of the outer sleeve comprises a locking opening making it possible for access to said locking member, the securing means are mounted in said opening. Thus, the operator can manually secure the locking means.

Preferably, the pipes are made of a plastic material.

Preferably, each pipe comprises at least one connection end with a coupling and at least one connection end without a coupling in order to make it possible for a coupling in series of several pipes.

Preferably, the sealing member comprises at least one upstream seal able to collaborate with the connection end of the first pipe and at least one downstream seal able to collaborate with the connection end of the second pipe.

The invention also relates to an aircraft comprising a fluid circuit such as presented above, wherein the first pipe and the second pipe are secured to a structure of the aircraft, the connection ends of the pipes being fixed and spaced apart by an axial connection clearance.

The invention further relates to a method for coupling a first pipe and a second pipe by means of a coupling of a fluid circuit according to the invention, the connection ends of the pipes being fixed and spaced apart by an axial connection clearance, the coupling extending over the connection end of the first pipe, the method comprises:

a step of movement from upstream to downstream of the outer sleeve of the coupling moved to the blocking member of the second pipe so as to move the sealing member between the two connection ends to ensure the sealing between the two pipes and

a step of locking the outer sleeve onto the second pipe.

Thus, the pipes are physically and fluidically connected in a simple and practical manner by an operator, preferably, using one single hand. Preferably, the step of locking is carried out automatically during the movement downstream.

Preferably, the coupling method comprises a step of securing the locking of the outer sleeve onto the second pipe so as to prevent any involuntary unlocking. Preferably, in the locked position, the locking means extend downstream of the blocking member of the second pipe.

### BRIEF DESCRIPTION OF THE DRAWINGS

The invention will be best understood upon reading the following description, given solely as an example, and in reference to the appended drawings, wherein:

FIG. 1 schematically shows a fluid circuit according to the invention comprising two coupled pipes;

FIG. 2 schematically shows a pipe according to an embodiment of the invention;

FIG. 3 is a schematic, cross-sectional view of a fluid circuit according to the invention comprising two non-coupled pipes;

FIG. 4 schematically shows a coupling according to an embodiment according to the invention;

FIGS. 5 to 8 show, cross-sectionally, steps of coupling two pipes according to an embodiment of the method of coupling according to the invention;

FIG. 9 shows, in perspective, coupled pipes;

FIG. 10 is a schematic, cross-sectional view of the steps of moving the outer sleeve during the coupling;

FIG. 11 is a diagrammatical partial cross-section view of a pipe provided with a plug; and

FIG. 12 is a schematic, cross-sectional view of another embodiment of a coupling according to the invention.

It must be noted, that the figures disclose the invention in a detailed manner to implement the invention, said figures being able, of course, to be used to best define the invention where necessary.

### DETAILED DESCRIPTION

A fluid circuit according to the invention intended for aeronautical use, in particular, for the transport of fuel, water and oxygen, air, firestop gas, etc. will now be presented.

In this example, the fluid circuit comprises a plurality of pipes which are coordinated with one another in order to guide a fluid. For an aeronautical application, the individual pipes are, in a first step, secured to a structure of an aircraft, then, in a second step, coupled together.

Below, the invention will be presented for the coupling of two pipes of a fluid circuit, but it goes without saying that the invention applies to the coupling of more than two pipes.

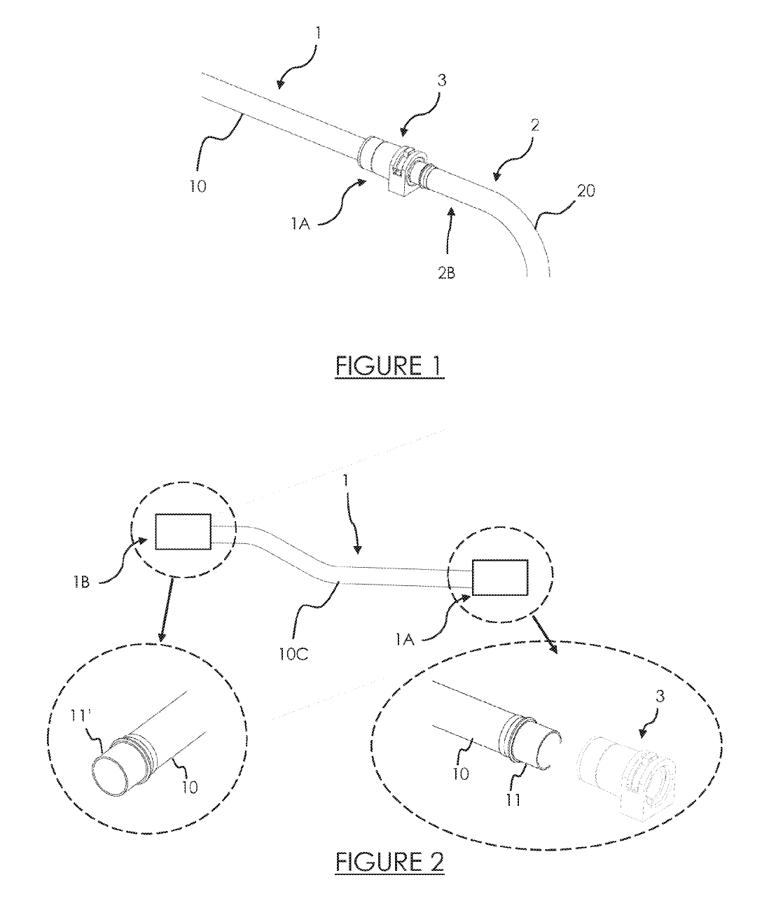

In reference to FIG. 1, an embodiment is shown of a fluid circuit according to the invention that comprises a first pipe 1, a second pipe 2 and a coupling 3, mounted on the first pipe 1, in order to couple the first pipe 1 to the second pipe 2.

In this embodiment, each pipe comprises a tubular body which is terminated at each end by a connection endpiece. Thus, each connection endpiece forms a connection end of the pipe. In this embodiment, for each pipe, a connection end is provided with a coupling and is designated “active connection end”, while the other connection end is devoid of a coupling and is designated as “passive connection end”. The tubular body of each pipe preferably comprises arched portions, so as to make it possible for the fluid circuit to connect different pieces of equipment practically by overcoming positioning constraints. In addition, each pipe defines an inner surface, in contact with the fluid to be conveyed, and an outer surface, opposite the inner surface.

In this example, the two pipes 1, 2 have a similar structure, with only the tubular bodies of the pipes 1, 2 being different. For reasons of clarity and concision, only the first pipe 1 shall be described in a detailed manner, the second pipe 2 being similar.

FIG. 2 schematically shows the first pipe 1 which comprises a tubular body 10 connected, on the one hand, to a first endpiece 11 provided with a coupling 3 in order to form an active connection end 1A and, on the other hand, a second endpiece 11′ with no coupling 3 in order to form a passive connection end 1B. As indicated in FIG. 2, the tubular body 10 comprises an arched portion 10C. The diameter of the tubular body 10 and/or of each connection end of the first pipe 1 is preferably between 6.35 mm and 50.8 mm. Preferably, the first pipe 1 is made of a plastic material, but it goes without saying that other materials could be suitable, for example, a metal material.

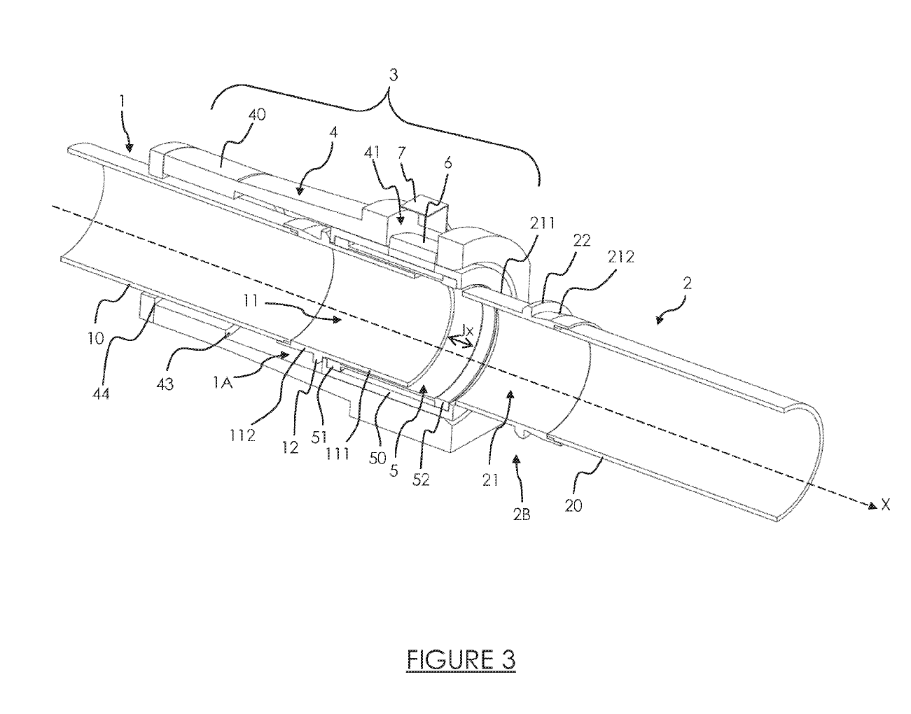

Below, in reference to FIG. 3, an active connection end 1A will be shown in reference to the first pipe 1 while a passive connection end 2B will be shown in reference to the second pipe 2 in order to show a coupling of the two pipes 1, 2.

In reference to FIG. 3, the connection ends 1A, 2B are aligned along an axis X and are spaced apart by an axial connection clearance Jx. In the figures, the axis X is oriented from upstream to downstream which corresponds to the direction of movement of the coupling 3 during a coupling.

The first endpiece 11 of the first pipe 1 comprises a blocking member 12 that extends radially protruding with respect to said axis X from the outer surface. In this example, the blocking member 12 is presented in the form of an annular ring, but it goes without saying that other shapes could be suitable, in particular, a serrated ring or a lug. Preferably, the blocking member 12 has an axial thickness of around 2 mm and a radial length of between 2 mm and 6 mm with respect to the axis X. In reference to FIG. 3, the first endpiece 11 successively comprises, from upstream to downstream, a first longitudinal portion 112, the blocking member 12 and a second longitudinal portion 111. In this example, the first longitudinal portion 112 comprises a length of around 10 mm while the second longitudinal portion 111 comprises a length of around 13 mm.

Similarly, the second endpiece 21 of the second pipe 2 comprises a blocking member 22 which extends radially protruding with respect to said axis X from the outer surface. In this example, the blocking member 22 is presented in the form of an annular ring, but it goes without saying that other shapes could be suitable. In a similar manner, the blocking member 22 has an axial thickness of around 2 mm and a radial length of between 2 mm and 6 mm with respect to the axis X. In reference to FIG. 3, the second endpiece 21 successively comprises, from upstream to downstream, a first longitudinal portion 212, the blocking member 22 and a second longitudinal portion 211. In this example, the first longitudinal portion 212 comprises a length of around 10 mm while the second longitudinal portion 211 comprises a length of around 17 mm. The blocking member 22 is flared from upstream to downstream, in order to make it possible for a progressive deformation of the locking means of the coupling as will be presented below. In this example, the connection endpieces 11, 21 are different, but it goes without saying that they could be identical.

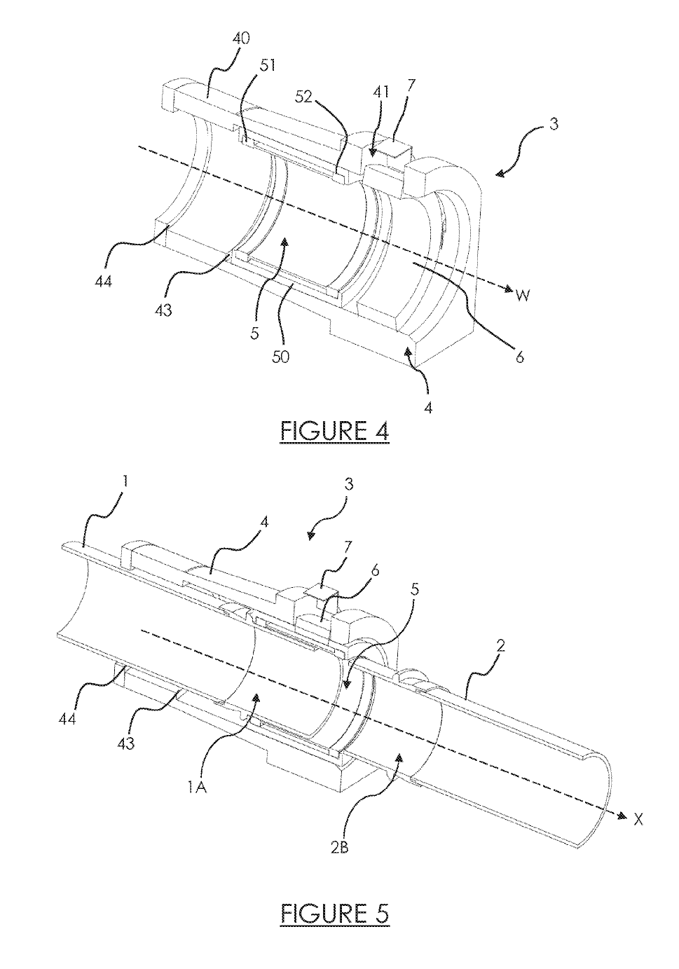

FIGS. 3 and 4 show a preferred embodiment of a coupling 3 according to the invention. The coupling 3 extends longitudinally along an axis W oriented from upstream to downstream. In the mounted position, the axes X and W are combined. The coupling 3 comprises an outer sleeve 4 wherein is mounted a sealing member 5 configured to sealingly connect the two connection ends 1A, 2B of the pipes\ 1, 2, in particular, the longitudinal ends 111, 211. According to the invention, the coupling 3 is configured to move the sealing member 5 between the two connection ends 1A, 2B to ensure sealing as the outer sleeve 4 is moved to the blocking member 22 of the second pipe 2. The coupling 3 further comprises locking means 6 configured to collaborate with the blocking member 22 of the second pipe 2 to block the translational movement of said outer sleeve 4 towards the first pipe 1 and securing means 7 configured to prevent any involuntary unlocking. As will be presented below, such a coupling 3 makes it possible to be handled with one hand by an operator so as to couple two pipes 1, 2, practically and reliably. The various elements of the coupling 3 will now be presented in detail.

As indicated in FIG. 4, the outer sleeve 4 is presented in the form of a peripheral casing that extends axially along the axis W. In the mounted position, the outer sleeve 4 is adapted to slide along the X axis on the active connection end 1A of the first pipe 1. The outer sleeve 4 comprises an upstream end intended to extend on the side of the first pipe 1 in the locked position and a downstream end intended to extend on the side of the second pipe 2 in the locked position.

In this example, the outer sleeve 4 comprises first abutment means configured to collaborate with the sealing member 5 in order to move it concomitantly with the movement of the outer sleeve 4. In this example, the first abutment means are presented in the form of a first abutment wall 43 adapted to collaborate with the sealing member 5. The first abutment wall 43 is annular and extends inside the outer sleeve 4. In this example, the first abutment wall 43 has an inner diameter that is greater than the outer diameter of the blocking member 12. In other words, the first abutment wall 43 extends radially outwards to the blocking member 12 of the first pipe 1 with respect to the axis X. Thus, the first abutment wall 43 is not impeded by the blocking member 12 to come into contact with the sealing member 5.

In reference to FIG. 4, the outer sleeve 4 comprises second abutment means configured to collaborate with the blocking member 12 of the first pipe 1 to prevent the removal of the outer sleeve 4 of the first pipe 1. Thus, the outer sleeve 4 cannot be removed from the first pipe 1, which facilitates the installation of the pipes. It goes without saying that the outer sleeve 4 could be removable in case of need.

In this example, the second abutment means 44 are presented in the form of a second abutment wall 44 which is annular and extends inside the outer sleeve 4. As indicated in FIG. 4, the second abutment wall 44 extends downstream of the first abutment wall 43. In this example, the second abutment wall 44 has an inner diameter greater than the diameter of the tubular body 10 and less than that of the blocking member 12. Thus, the second abutment wall 44 comes into contact with the blocking member 12 during a movement downstream. The second abutment means 44 are upstream of the first abutment means 43.

In addition, it goes without saying that the coupling 3 could comprise other abutment means to prevent the removal of the main sleeve of the first pipe. In particular, the abutment means could be presented in a form similar to that of the locking means which will be presented below.

In reference to FIG. 4, the sealing member 5 is mounted with the ability to slide along the axis W in the inside cavity of the outer sleeve 4. In this example, the sliding clearance is low between the sealing member 5 and the outer sleeve 4, which generates friction. The sliding clearance is configured so as to enable a sliding, only when the operator is carrying out a voluntary movement by applying a force on the outer sleeve 4. In other words, the sealing member 5 cannot be moved in the outer sleeve 4, simply by gravity and/or under the effect of vibrations. In this example, the sliding clearance during a translational movement along the X axis is less than 6.5 mm.

The sealing member 5 is configured to sealingly connect the two connection ends 1A, 2B. To this effect, it has an inner diameter that is substantially greater than the outer diameter of the longitudinal portions 111, 211 of the endpieces 11, 21 of the pipes 1, 2. Such a sizing advantageously makes it possible to prevent a substantial volume of liquid from stagnating in the sealing member 5, which is particularly advantageous for the transportation of drinking water or fuel.

In reference to FIG. 4, the sealing member 5 comprises a cylindrical body 50, extends axially along the axis W and open along the axis W, wherein is mounted an upstream seal 51 able to collaborate with the connection end 1A of the first pipe 1 and a downstream seal 52 able to collaborate with the connection end 2B of the second pipe 2. In this example, the seals 51, 52 are secured to and form a single-piece sealing element. In this embodiment, each seal 51, 52 is made of elastic material.

Still in reference to FIG. 4, the locking means are presented in the form of a locking member 6 which is peripheral and mounted inside the outer sleeve 4. In this example, the locking member 6 comprises two hinged jaws which are suitable for being open in the unlocked state and closed in the locked state. The locking member 6 is made of elastic material and is configured to return to the shape thereof in the locked state after a deformation.

More specifically, the locking member 6 is configured to be deformed radially during the contact thereof with the blocking member 22 of the second pipe 2 during the movement of the coupling 3 downstream. As indicated above, the blocking member 22 of the second pipe 2 comprises a flared wall so as to guide the deformation of the locking member 6. Preferably, the locking member 6 is adapted to be deformed under the effect of a mechanical force applied by the operator. After the contact with the blocking member 22 of the second pipe 2, the locking member 6 retracts radially.

As indicated in FIG. 3, the locking member 6 is mounted at the downstream end of the outer sleeve 4 so as to extend downstream of the blocking member 22 of the second pipe 2 in the locked position. Thus, the outer sleeve 4 can no longer be moved upstream. The downstream end of the outer sleeve 4 comprises a locking opening 41 that makes it possible for the locking member 6 to expand radially. The sealing member 5 is mounted with the ability to slide along the axis X in the inside cavity of the outer sleeve 4 and is blocked downstream by the locking member 6 and upstream by the first abutment wall 43. It goes without saying that the locking means could have various shapes.

As indicated above, the locking member 6 being deformable between a locked state and an unlocked state, the coupling 3 comprises securing means configured to prevent a deformation in the locked state. In other words, in this example, the securing means prevent a radial expansion of the locking member 6.

The securing means are mounted in the locking opening 41. Thus, the operator can manually secure the locking member 6. In this example, the securing means are presented in the form of a securing member in the form of a curved strip, of which the shape is modified between the secure and non-secure state thereof. Thus, an operator can quickly and practically determine if a coupling is secure via a simple visual observation. It goes without saying that the securing means could have various shapes.

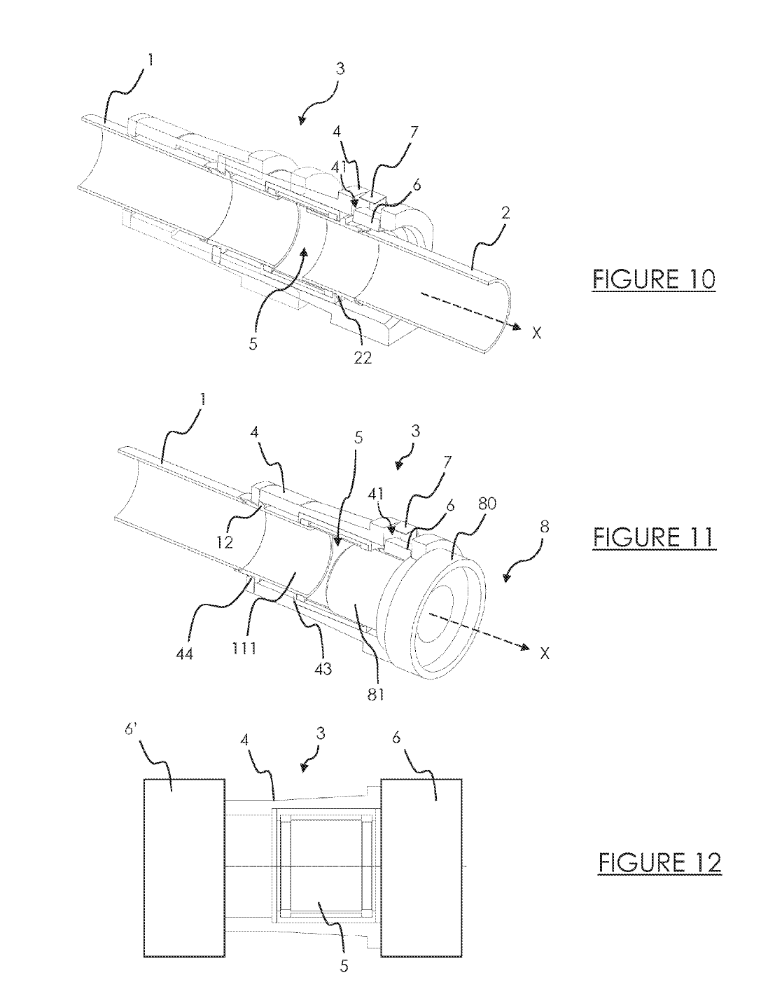

To assemble the coupling 3 to the first pipe 1, the outer sleeve 4 is inserted from downstream to upstream onto the tubular body 10 of the first pipe 1 then the first endpiece 11 is fixed, from downstream to upstream, onto the tubular body 10, for example, by crimping, welding or gluing. Thus, the outer sleeve 4 can no longer be removed. Then, the sealing member 5 is inserted from downstream to upstream so as to radially extend outwards to the second longitudinal portion 111 of the first pipe 1 and radially inwards to the outer sleeve 4. In order to prevent any damage or relative movement in the coupling 3 during the transport thereof, a plug 8 is, preferably, inserted at the downstream end so as to extend in the sealing member 5, as shown in FIG. 11.

As will be presented below, the coupling 3 can be made removable from the first pipe 1.

A method for coupling a first pipe 1 and a second pipe 2 by means of a coupling 3 will now be presented. In this example, the pipes 1, 2 have been secured beforehand to a structure of an aircraft and are not movable in relation to one another.

In reference to FIG. 5, the connection ends 1A, 2B of the pipes 1, 2 are fixed and spaced apart by an axial connection clearance Jx, the coupling 3 extending over the connection end 1A of the first pipe 1. The outer sleeve 4 is upstream from the connection end 1A and the sealing member 5 extends radially outwards to the second longitudinal portion 111 of the first pipe 1 and radially inwards to the outer sleeve 4.

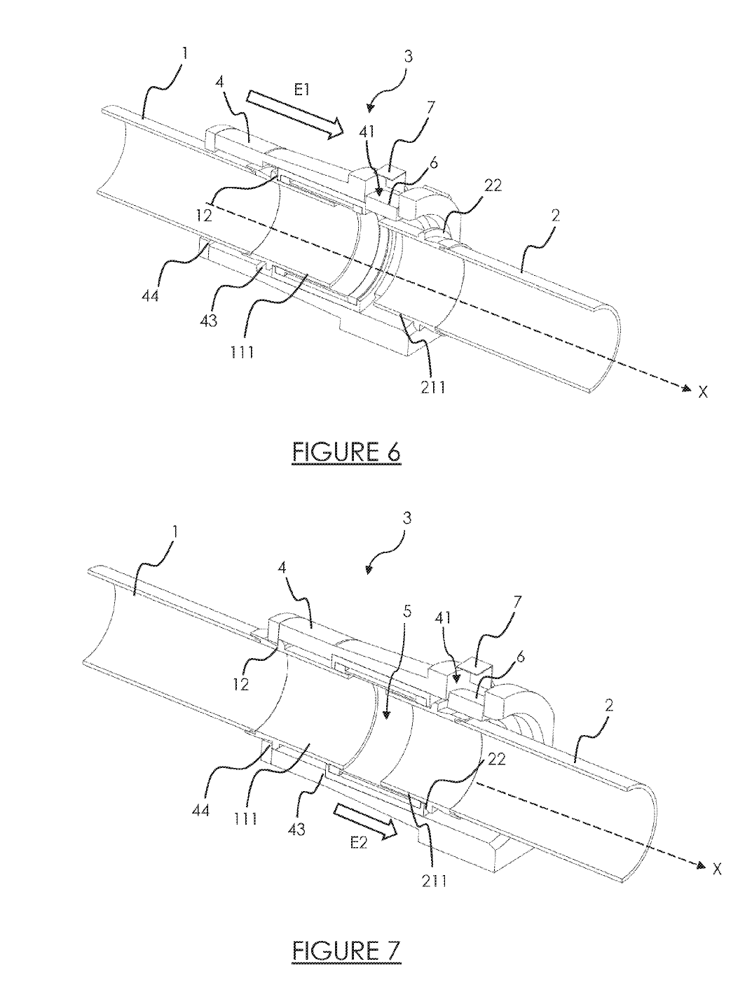

In reference to FIG. 6, the coupling method comprises a step of moving E1, from upstream to downstream, the outer sleeve 4 of the coupling 3 as far as the blocking member 22 of the second pipe 2 so as to move the sealing member 5 between the two connection ends 1A, 2B to ensure the sealing between the two pipes 1, 2.

In this example, the operator moves the outer sleeve 4 from upstream to downstream with one single hand, such that the first abutment wall 43 avoids the abutment member 12 of the first pipe 1 and abuts with the sealing member 5 in order to move it downstream towards the second pipe 2. As the movement occurs, the sealing member 5 reaches the second longitudinal portion 211 of the second pipe 2 as shown in FIG. 7. The seals 51, 52 collaborate respectively with the second longitudinal portions 111, 211 of the pipes 1, 2, which ensures a sealed connection.

In reference to FIG. 7, the coupling method comprises a step of locking E2 the outer sleeve 4 onto the second pipe 2. During the downstream movement of the outer sleeve 4, the locking member 6 comes into contact with the blocking member 22 of the second pipe 2 and expands radially due to the flared shape of the blocking member 22. The operator must exert a mechanical stress to deform the locking member 6, but the latter remains reasonable. As the movement takes place, the locking member 6 crosses the blocking member 22 of the second pipe 2 then retracts once located downstream as shown in FIG. 7. This results in that the outer sleeve 4 can no longer be moved downstream without the operator exerting a force on the outer sleeve.

Preferably, the course of travel downstream of the outer sleeve 4 is limited by the second abutment wall 44 which abuts with the blocking member 12 of the first pipe 1 as shown in FIG. 7. As an example, the course of travel from upstream to downstream of the outer sleeve 4 is schematically shown in FIG. 10. Advantageously, the axial course of travel of the outer sleeve 4 on the connection end 1A is reduced. Also, in this example, the connection end 1A must solely comprise a straight portion with a length greater than 6 cm before being able to be arched.

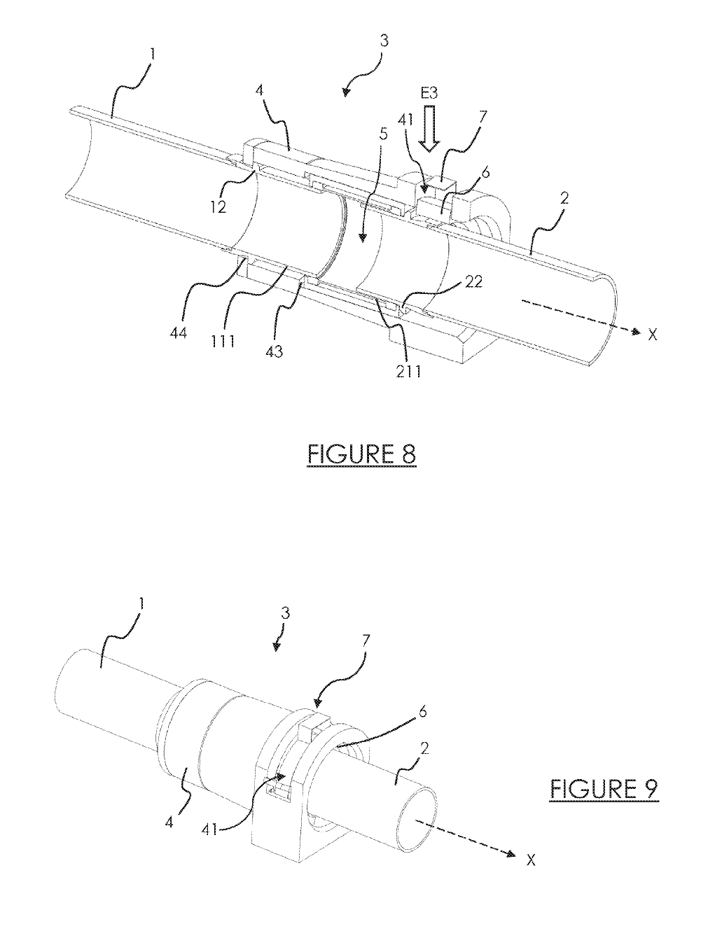

In reference to FIG. 8, the coupling method comprises a step of securing E3 the locking of the outer sleeve 4 onto the second pipe 2 so as to prevent any involuntary unlocking. In this example, the operator presses on the securing member 7 which is moved in the locking opening 41 of the coupling 3 in order to prevent any radial expansion of the locking member 6. The outer sleeve 4 can then not be removed involuntarily. Preferably, the operator must use a tool to remove the security and remove the outer sleeve 4. As indicated hereinabove, a secure coupling can be identified by a simple visual observation, which facilitates inspection operations. As an example, FIG. 9 shows a non-secure coupling.

Thanks to the invention, two pipes 1, 2 can be physically and fluidically coupled by an operator without the risk of error and in practically. Furthermore, from a maintenance standpoint, the sealing member 5 can be removed in a practical manner from the outer sleeve 4 when the pipes 1, 2 are secured to the structure of an aircraft. Thus, in case of wear, the sealing member 5 can be replaced easily without requiring an operation of removing the fluid circuit.

Alternatively, and in reference to FIG. 12 which shows another form of a coupling, as a second abutment means, instead of the second abutment wall 44, the coupling could comprise upstream locking means 6′ such as shown above in order to make it possible for a removal of the outer sleeve 4 of the first pipe 1 after securing said first pipe 1 to the structure of the aircraft. In other words, it is sufficient to unlock the upstream locking means 6′ to make it possible for the removal of the outer sleeve 4 downstream. Such a coupling 3 can be replaced quickly and practically.

1. A fluid circuit, particularly for an aircraft, comprising a first pipe, a second pipe and a coupling,
each pipe comprising a connection end, which extends along an axis X and which defines an inner surface and an outer surface, which comprises a blocking member extending as a radial protrusion with respect to said axis X from the outer surface, the connection ends of the pipes being fixed and spaced apart by an axial connection clearance,
the coupling comprising:
an outer sleeve which extends along the axis X and is mounted with the ability to slide along the axis X at the connection end of the first pipe, the outer sleeve being configured to connect the two connection ends during a movement from upstream to downstream,
a sealing member which extends along the axis X and is mounted with the ability to slide along the axis X in said outer sleeve, the sealing member being configured to sealingly connect the two connection ends,
locking means configured to collaborate with the blocking member of the second pipe to block the translational movement of said outer sleeve upstream towards the first pipe,
the coupling being configured to move the sealing member between the two connection ends to ensure sealing as the outer sleeve towards the upstream is moved to the blocking member of the second pipe.

2. The fluid circuit according to claim 1, wherein the outer sleeve comprises first abutment means configured to collaborate with the sealing member in order to move it concomitantly with the movement of the outer sleeve.

3. The fluid circuit according to claim 2, wherein the first abutment means extend radially outside the blocking member of the first pipe with respect to the axis X.

4. The fluid circuit according to claim 1, wherein the outer sleeve comprises second abutment means configured to collaborate with the blocking member of the first pipe to prevent the removal of the outer sleeve of the first pipe.

5. The fluid circuit according to claim 1, wherein the outer sleeve comprising an upstream end intended to extend on the side of the first pipe in the locked position and a downstream end intended to extend on the side of the second pipe in the locked position, the locking means are mounted at the downstream end of the outer sleeve.

6. The fluid circuit according to claim 1, wherein, the locking means being deformable between the locked and unlocked state thereof, the coupling comprises securing means configured to prevent a deformation of the locking means in the locked state.

7. The fluid circuit according to claim 1, wherein the sealing member comprises at least one upstream seal able to collaborate with the connection end of the first pipe and at least one downstream seal able to collaborate with the connection end of the second pipe.

8. An aircraft comprising the fluid circuit according to claim 1, wherein the first pipe and the second pipe are secured to a structure of the aircraft, the connection ends of the pipes being fixed and spaced apart by an axial connection clearance.

9. A method for coupling a first pipe and a second pipe by means of a coupling of the fluid circuit according to claim 1, the connection ends of the pipes being fixed as spaced apart by an axial connection clearance, the coupling extending over the connection end of the first pipe, the method comprises:
a step of moving from upstream to downstream of the outer sleeve of the coupling to the blocking member of the second pipe so as to move the sealing member between the two connection ends to ensure the sealing between the two pipes, and
a step of locking the outer sleeve onto the second pipe.

10. The coupling method according to claim 9, comprising a step for securing the locking of the outer sleeve onto the second pipe so as to prevent any involuntary unlocking.
